(19) United States
(12) Patent Application Publication
(10) Pub. No.: US 2016/0112871 A1
(43) Pub. Date: Apr. 21, 2016

(54) Method and Systems for Placing Physical Boundaries on Information Access/Storage, Transmission and Computation of Mobile Devices

(71) Applicant: Christopher Jules White, Nashville, TN (US)

(72) Inventor: Christopher Jules White, Nashville, TN (US)

(21) Appl. No.: 14/517,577

(22) Filed: Oct. 17, 2014

(51) Int. Cl. H04W 12/06

(52) U.S. Cl. CPC H04W 12/06

(57) ABSTRACT

A system and method for restricting access to information using short range wireless communications, the system is provided. The system and method include a short range wireless network serving a predetermined enabled location. The network is configured to provide authentication data to a computing device. The authentication data specific may be specific to an enabled location and may further include a unique identifier. The network is configured to receive from authentication data from the computing device. The network is further configured to verify the authentication data received from the computing device and, upon verification, the network permits communication between the computing device and the network for the enabled location.

### RELATED APPLICATIONS

Not applicable.

### STATEMENT REGARDING FEDERALLY SPONSORED RESEARCH & DEVELOPMENT

Not applicable.

### INCORPORATION BY REFERENCE OF MATERIAL SUBMITTED ON A COMPACT DISC

Not applicable.

### BACKGROUND OF THE INVENTION

Mobile devices, such as smartphones, tablets, laptops, and other web-connected devices are widely used. The devices often collect, store, process and communicate data which often includes personal and/or confidential information such as personal contacts, financial information and business materials of the senders or receivers.

As the use of mobile computing devices has increased, so too have efforts to exploit vulnerabilities in the devices, related systems and associated software to gain unauthorized access to and use of data through these devices. The vulnerabilities of computing devices are heightened when communications links between the devices are established in settings away from firewalls and other security measures.

As a result, the need for security or establishing authorized communications between devices is an increasing area of concern in the field of computing. This is especially true when devices are used in a wide variety of different locations. Particularly challenging is securing mobile device information when the device is operated in a specific room, rooms, or location. Determining whether or not a device is even within a building or has entered a spec room is also problematic.

GPS, cellular signal triangulation, and Wi-Fi SSID signal analysis are the predominant approaches employed to localize users. However, each of these approaches have inaccuracy issues. Moreover, the signals that these approaches use can travel significant distances beyond an intended boundary making them difficult to use as a reliable in-room proximity detection mechanism.

### BRIEF SUMMARY OF THE INVENTION

In one embodiment, the present invention concerns a method and system for restricting the access, storage, and transmission of information between devices within an enabled location. In this embodiment, a device upon entering an enabled location is given access to data via a proximity signal. The signal is configured to be a short-range signal with a range substantially confined to the location, room, boundary or area in which a communication link or access is to be granted. Receipt of the signal provides secure access to designated data and thereby safeguards against designated data or communications being accessed by an unauthorized device or by unauthorized communications. Moreover, the embodiment may prevent accessed data from being durably stored on the device. The embodiment also may ensure that data accessed by the device while in the enabled location will be removed from the device and access to it revoked when the user has left the enabled location.

In another embodiment, the present invention provides a method and system for providing secure access to data by utilizing proximity authentication and related proximity signals to establish initial and authorized communications. In addition, dynamic control may be used to alter the synchronization signals between a device that has entered an enabled location and one or more servers or other devices within a specifically enabled location. Once communication is established, synchronization data may further be used to dynamically alter communications between the mobile device and other servers or devices in order to prevent unauthorized access to the communications. Exchanging synchronization data within the enabled location and coupling it with at least one proximity authentication signal minimizes the potential of data being intercepted or interfered with while avoiding performance and flexibility limitations of preconfigured approaches.

In yet another embodiment, the present invention provides a method and system for proximity authentication for mobile devices thereby establishing when a device has entered or exited a specific area. Such authentication can be used to control linked communications as well as device access to specific resources or capabilities while the device is located within the designated area. Moreover, the present invention may also be used to control the mobile device, such as inter-process communications of the device, while the device is in the enabled location.

In another embodiment, the present invention defines a restricted access zone or enabled location with at least one proximity authentication signal that is accessible by a device located in the zone but not accessible beyond the zone. Upon entering the restricted location, the device is authenticated and permitted to operate within the zone to perform data communications through the use of, among other things, proximity signals. The proximity signals are configured to stay within the zone or enabled location. Upon leaving the zone, data communication is disabled and any data transferred to the device or used by the device may be automatically removed.

### BRIEF DESCRIPTION OF THE SEVERAL VIEWS OF THE DRAWINGS

In the drawings, which are not necessarily drawn to scale, like numerals may describe substantially similar components throughout the several views. Like numerals having different letter suffixes may represent different instances of substantially similar components. The drawings illustrate generally, by way of example, but not by way of limitation, a detailed description of certain embodiments discussed in the present document.

FIG. 1 is a block diagram of a wireless network system that may be used to enable direct or indirect wireless communications between devices in accordance with some embodiments of the present invention.

FIG. 2 shows how data flows through a mobile device in some embodiments of the invention.

FIG. 3 is a flowchart showing steps that may be taken to create an authorized communication at an enabled location.

FIG. 4A shows an overview of proximity configuration using hopping communications.

FIG. 4B shows an overview of the termination of a proximity configuration using hopping communications.

FIG. 5 shows how data flows through a mobile device in another embodiment of the invention.

FIG. 6 is a block diagram of a system that provides location-based content over a wireless communications path to one or more mobile devices in accordance with the principles of the present invention.

FIG. 7 is a block diagram of a system that provides location-based content over a wireless communications path to one or more mobile devices in accordance with the principles of the present invention.

FIG. 8 illustrates how one or more wireless routers may be used to define an enabled location for use with a mobile device in accordance with the principles of the present invention.

FIG. 9 is a flowchart showing steps that may be taken to provide localized content or data to a mobile device in accordance with the principles of the present invention.

### DETAILED DESCRIPTION OF THE INVENTION

Detailed embodiments of the present invention are disclosed herein; however, it is to be understood that the disclosed embodiments are merely exemplary of the invention, which may be embodied in various forms. Therefore, specific structural and functional details disclosed herein are not to be interpreted as limiting, but merely as a representative basis for teaching one skilled in the art to variously employ the present invention in virtually any appropriately detailed structure or system. Further, the terms and phrases used herein are not intended to be limiting, but rather to provide an understandable description of the invention.

As used herein, “mobile device” means any non-stationary computing device, such as smartphones, tablets, laptops, and other web-connected devices that are configured to communicate and/or link wirelessly with other devices.

As used herein, “access control device” means any stationary system, computer, processor, server, part of a server, cloud server, client server, network infrastructure, computing platform, stationary computing platform, smart card, router, network, or other platforms which are able to communicate with a mobile device.

As used herein, “enabled location” means at least one room, building, location, zone or area, context or environment which defines a predetermined boundary in which a signal is accessible by a mobile device. In addition, an “enabled location” also means any physical space having one or more mobile and access control devices that need to communicate securely. It also includes a location where one or more authorized mobile and access control devices move together, for example, on a mission or during a trip.

As used herein, “short-range” means with a relatively short-range wireless communication protocol such as Wi-Fi (e.g., a 802.11 protocol), Bluetooth (registered trademark), high frequency systems (e.g., 900 MHz, 2.4 GHz, and 5.6 GHz communication systems), or other localized wireless communication protocol.

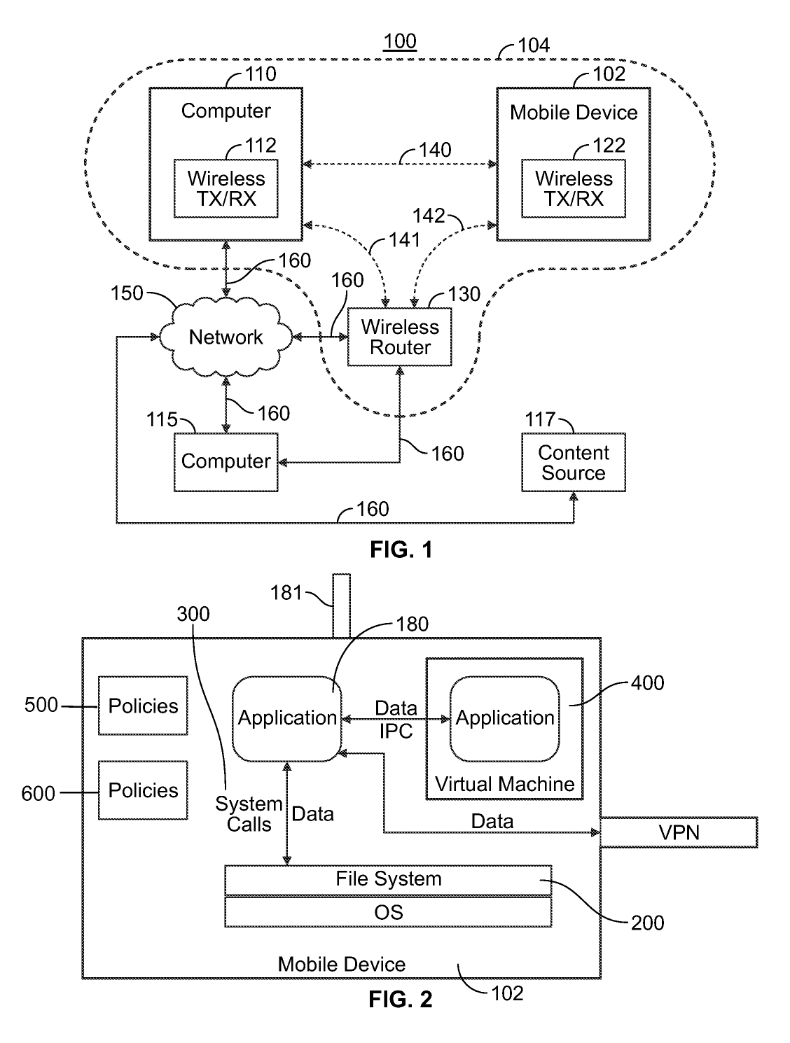

As shown in FIG. 1, one embodiment of the present invention provides a wireless network system 100 for enabling a mobile device to wirelessly communicate directly or indirectly with a computer or another access control device in accordance with the principles of the present invention. Mobile device 102 may wirelessly communicate with a host computer or access control device in any number of ways. Wireless communication in enabled location 104 may be performed with a short-range wireless communication protocol such as Wi-Fi (e.g., a 802.11 protocol), Bluetooth (registered trademark), high frequency systems (e.g., 900 MHz, 2.4 GHz, and 5.6 GHz communication systems), or other relatively localized wireless communication protocols such as Near-Field communication (NFC). Use of localized wireless communication may provide a localized region or enabled location 104 (shown by a dashed-line bubble) where wireless communication among mobile devices and access control devices located within that region or location is possible.

The mobile and access control devices located within localized region 104 may wirelessly communicate over one or more local wireless communication paths 140, 141, and 142. A local wireless communication path enables wireless communication using a short-range communications protocol. When a mobile device is not within region 104, that mobile device may be out of range and not able to wirelessly communicate with an access control device located within region 104.

In a preferred embodiment, system 100 may include access control devices such as computers 110 and 115. Computer 110 may include short-range wireless communication circuitry 112 which may operate to enable computer 110 to wirelessly communicate indirectly or directly according to one or more short-range communication protocols. Computer 110 may directly communicate with mobile device 102 over local wireless path 140. Computer 110 may also indirectly communicate with mobile device 102 through a communications link including local wireless path 141, wireless router 130, and local wireless path 142. Wireless router 130 may be used to expand the range of localized region 104, and if desired, additional hardware may also be deployed to expand the scope of enabled location 104.

Computer 115 may use wireless router 130 to wirelessly communicate with mobile device 102. The communications links between computer 115 and a mobile device may include path 160, wireless router 130, and local wireless path 142. Path 160 may be any communications link for transmitting signals.

Computers 110 and 115 may be a personal computer, a desktop computer, a laptop computer, or a server or a combination thereof. Computers 110 and 115 may include storage devices such as hard-drives and memory, user-interface tools and displays. Wireless router 130 and computers 110 and 115 may be connected to network 150 via path 160. Network 150 may be a public network such as the Internet, a local area network, a wide area network, a private network, telephone network, cable network, broadband network, Ethernet network, digital subscriber line (DSL) network, or any other network that enables linked communications between computers and devices.

The network may be connected to at least one content or data source 117. Content source 117 provides data, digital content, software, communications other information and performs related processes. For example, a content source may store and distribute software, data, digital media or any other desired information such as information relevant to a particular enabled location. For example, if the enabled location is a retail establishment, information concerning the establishment, the services provided, or associated products may be provided.

In addition, an enabled location may be a region within a structure or location and may be configured to concern only a single product, service or predetermined data. To minimize associated equipment, the system may also be configured to limit the content associated with only that particular product or enabled location. Accordingly, content provided by content source 117 may be provided, for example, to mobile device 102 over a path including network 150, wireless router 130, and local wireless path 142, bypassing computers 110 and 115. Content may also be provided by a small-scale computer and transmitter over path 140. Content source 117 may further include transaction equipment for processing requests made through mobile device 102 such as purchase orders or requests for content. In addition, content source 117 may include one or more databases for keeping track of which data has been accessed or which content has been purchased and liar storing data or information specific to a particular mobile device or user.

Mobile device 102 may also be an electronic device capable of wirelessly communicating with another mobile device, access control device, computer 110, or router 130 using a short-range communication protocol. In some embodiments, as shown in FIG. 2, circuitry or components to restrict communications to authorized communications within an enabled location may be integrated within a mobile device. The components may include first component 180, which may use one or more proximity signals issued by an access control device to control, alter, modify, enable or disable one or more inter-process communications. A second component 200 may use one or more file systems that use one or more proximity signals to control one or more file systems and one or more mount points. Component 300 may use proximity signals to control system call access. Component 400 may use proximity signals to control virtual machines and application containers. Component 500 may use one or more proximity signals to control one or more virtual networks or one or more private networks. Component 600 may use one or more policies with one or more proximity signals. The components may comprise one or more software applications or firmware applications and one or more processors that are configured to perform the operations set forth above within the mobile device, or remotely from the mobile device lay servers, access control devices or networks or in combinations thereof.

Existing approaches use static restrictions on inter-process communication to isolate applications and services from one another. Process isolation prevents applications and services from corrupting each other's memory, crashing each other, inappropriately accessing each other's data, and incorrectly changing each other's state. To interact with one another, these processes use inter-process communication mechanisms, such as message passing, RPC, object-oriented binder communication, shared memory segments, and other mechanisms.

An aspect of the present invention is that it may have control over computation, information access, service usage, and hardware resources by governing one or more of the inter-process communication mechanisms described above. When a mobile device needs to securely access information or perform specific computations only within a given enabled location, these communication mechanisms may be dynamically adapted or altered. For example, an inter-process communication to an email application or service may need to be monitored and altered, or disabled to prevent its use. This, in turn, prevents information from leaving an enabled location. One embodiment of the present invention, utilizing component 180, provides a mechanism for dynamically governing the inter-process communication mechanisms within a system based on at least one proximity signal or a set of signals received and/or sent over one or more of paths 140 or 142 as shown in FIG. 1.

When the one or more proximity signals are present, the mobile device examines the characteristics and/or data contained within those signals to determine if it is located within an enabled location. When the mobile device is deemed to be within a given enabled location, the inter-process communication mechanism is adapted to control computation and access based on predetermined policies governing computation and information access applicable to the enabled location.

As shown in FIG. 2, component 180 uses data transmitted is one or more proximity signals 181 and/or the characteristics of one or more proximity signals to determine if mobile device 102 is within or not within an enabled location. As shown in FIG. 1, an access control device, which may be computer 110, may generate the proximity signals and other communication signals with mobile device 102. As a result of determining that mobile device 102 is within or not within an enabled location 104, changes, alterations, or modifications (which may be temporary) to the governance or operation of the inter-process communication mechanism of the mobile device may be made.

One or more inter-process communications of the mobile device may be blocked, altered, modified, enabled, or disabled. Communications that may be blocked include, but are not limited to, one or more communications that meet certain characteristics such as IPC calls to send locked data to an enabled location or to another application capable of sending the information outside the enabled location. Inter-process communication of the mobile device may be may be blocked, altered, modified, enabled, or disabled by, for example, automatically removing sensitive information from inter-process communication call data. Inter-process communications of the mobile device may be enabled or disabled for specific applications, services, processes, or for designated parts of the mobile device or for applications such as phone calls, text messaging and the like. The senders or receivers of inter-process communication may alter how they send or receive data or what other parts of the system are allowed to communicate with them. Permissions governing the mobile device or access control device may change what inter-process communication an application, service, process, or other system component is allowed to use, make or receive.

The policies governing the inter-process communication call may be optionally controlled and changed by a remote server. The policies governing the inter-process communication call changes may optionally be dynamically transmitted to the mobile device from an access control device upon determining that the mobile device has entered or exited a designated location, environment, enabled location or context.

The policies governing the inter-process communication may be optionally stored or accessed on machine readable media that may include: computer components, devices, and recording media that retain digital data used for computing for some interval of time; semiconductor storage known as random access memory (RAM); mass storage typically for more permanent storage, such as optical discs; forms of magnetic storage like hard disks, tapes, drums, cards and other types; processor registers, cache memory, volatile memory, non-volatile memory; optical storage such as CD and DVD; removable media such as flash memory (e.g. USB sticks or keys), floppy disks, magnetic tape, paper tape, punch cards, standalone RAM disks, Zip drives, removable mass storage, off-line and the like; and other computer memory such as dynamic memory, static memory, read/write storage, mutable storage, read only, random access, sequential access, location addressable, file addressable, content addressable, network attached storage, storage area network, bar codes, magnetic ink, and the like.

The policies governing the inter-process communication may be optionally decrypted after receiving as key that is transmitted from the access control device on entrance or exit from an enabled location. The key may be time based. In response to detection of unauthorized signals or signal characteristics, the mobile device or access control device may automatically filter, block, or alter one or more inter-process communications.

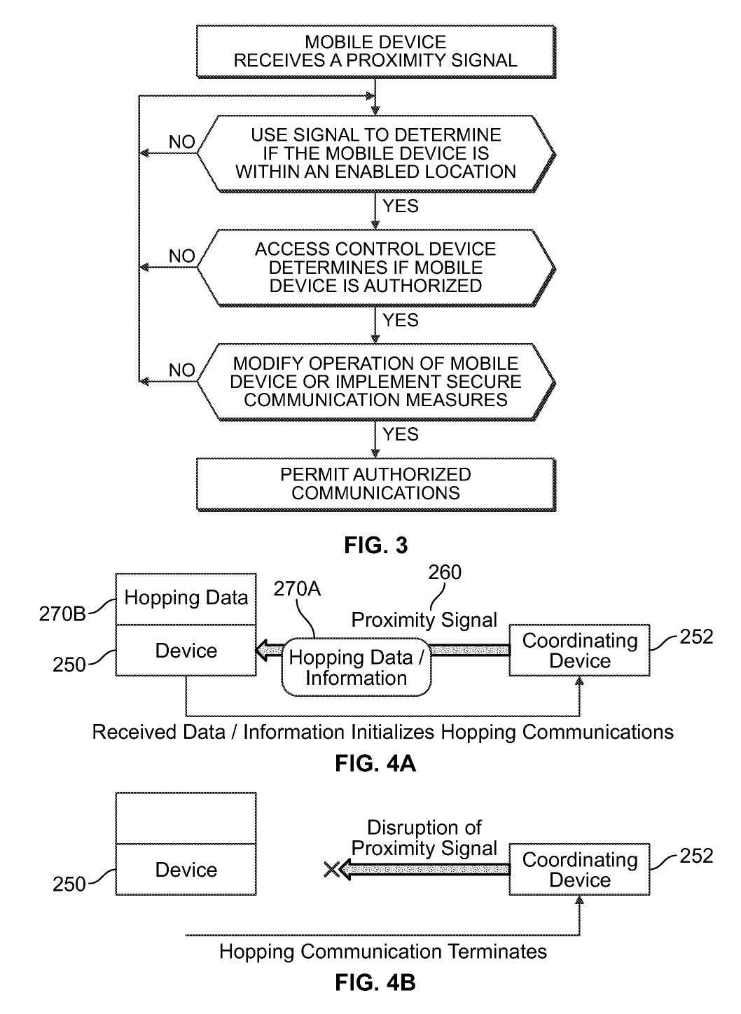

As shown in FIG. 3, steps 190-194 may be taken to create an authorized communication at an enabled location based on the above described embodiments. At step 190, a mobile device receives a proximity signal which may be an authorization signal. At step 191, the mobile device uses data transmitted via one or more proximity signals 181 and/or the characteristics of one or more proximity signals to determine if mobile device 102 is within or not within an enabled location. A characteristic that may be associated with a proximity signal is a time stamp or other method for determining when a signal was sent or receive. At step 192, the mobile device sends a signal to the access control device, which may be computer 110, to allow the mobile device to be authorized to receive further communication signals after determining that the mobile device is authorized. At step 193, as a result of determining that mobile device 102 is within or not within an enabled location 104 and authorized, the system proceeds to step 194. Also, prior to proceeding to step 194, changes, alterations, or modifications (which may be temporary) to the governance or operation of the inter-process communication mechanism of the mobile device may be made as described herein. At step 194, the mobile device is allowed to receive data and/or further engage in allowed or authorized communications.

As further shown in FIG. 2, component 200 uses proximity signals to control one or more file systems or one or more mount points. For example, one embodiment uses either in-memory or encrypted file systems that are dynamically mounted or un-mounted on entrance and exit from an enabled location. This reduces the need to change the source code of an application to ensure data is not durably stored as well as errors caused by blocking file system calls.

In addition, in one specific embodiment, the present invention may be used with email programs that consume sensitive data and often store it on a mobile device. As discussed herein, the present invention may be used when a mobile device is lost to prevent unauthorized access to data stored on the mobile device.

In one preferred embodiment, component 200 may automatically mount or un-mount one or more in-memory file systems based on one or more proximity signals received by an access control device. The present invention may also automatically encrypt or decrypt one or more file systems and attach one or more mount points based on one or more proximity signals, or automatically copy data between one or more mount points based on one or more proximity signals based on certain characteristics of the proximity signal such as a time stamp.

For an in-memory file system embodiment of the present invention, the directories that an application can store data in are dynamically mounted as an in-memory file system on entrance to an enabled location, which can be detected using one or more proximity signals. Preferably, any changes to the file system are only stored in the memory of the mobile device.

When a mobile device determines that it has left a particular enabled location, based on proximity signal analysis, it may un-mount the in-memory file system irrevocably removing all traces of any data that the application stored in the file system while in the enabled location. If needed, the device can optionally transmit the changes made to the file system back to a server so that they can be dynamically downloaded and loaded into memory on re-entrance into the enabled location.

Because in some cases it may be preferable to avoid storing data in memory, or prevent unwanted pirating, tampering, with, access to, or communication, an alternate embodiment of the invention uses an encrypted file system. The key to decrypt data from the file system is dynamically downloaded from an access control device when a proximity authentication protocol is completed. The key is stored in memory only on the device. When the device determines via one or more proximity signals that it has left an enabled location, the encryption key may be irrevocably wiped from the memory of the device.

For an embodiment using the in-memory file system approach, data received or stored in the enabled location will not exist on the mobile device once it is determined via one or more proximity signals that it has left the enabled location. For an embodiment using the encrypted file system approach, data received or stored on the mobile device, while in the enabled location, may remain on the mobile device but not be accessible to either the mobile device's user or another individual that obtains the mobile device.

In another embodiment, based on data and/or signal characteristics from one or more proximity signals, a mobile device determines that it has entered a specific enabled location. In response to entering the enabled location, the mobile device optionally stops any processes that will be assigned to use the in-memory file system. When the mobile device detects it has entered an enabled location, the mobile device mounts an in-memory file system such as a Linux, tmpfs or ramfs file system.

In yet another embodiment, the in-memory file system may be optionally mounted on top of an existing directory used by one or more applications or services. The mobile device optionally copies bootstrapping data, such as application configuration data, to the in-memory file system. The mobile device optionally downloads additional state data, such as secure information or information stored in the in-memory file system during a previous session, to the in-memory file system. The mobile device optionally launches any applications or services that will manage the in-memory file system.

Unmodified applications and services are allowed to download sensitive information and store it on the in-memory file system. Since the file system appears identical to other file systems and may be mounted on top of existing application and service data directories, the applications and services can use it without modification. On detection of data received from or analysis of one or more proximity signals, the mobile device unmounts the in-memory file system. The mobile device optionally stops applications and services that have accessed the in-memory file system or may have received information from it. The mobile device optionally saves changes or the entire state of the in-memory file system to an external server before exiting the enabled location.

In response to detection of unauthorized signals or signal characteristics, the mobile device may automatically revert to the out-of-enabled location state by mounting or un-mounting one or more file systems. Alternately, the mobile device may enter a state that indicates possible tampering or that an attack has occurred.

Based on data or signal characteristics from a proximity signal, a mobile device determines that it has entered a specific enabled location. In response to entering the enabled location, the mobile device optionally stops any processes that will be assigned to use an encrypted file system and uses a proximity authentication protocol to obtain a decryption key for an encrypted file system from an access control device. The encryption key is stored in memory and used to decrypt data from the encrypted file system as needed. The encrypted file system is mounted on the mobile device. The encrypted file system is optionally mounted on top of an existing directory used by one or more applications or services. The device optionally copies bootstrapping data, such as application configuration data, to the encrypted file system. The mobile device optionally downloads additional state data, such as secure information, to the encrypted file system. The mobile device optionally launches any applications or services that will manage the encrypted file system. Unmodified applications and services are allowed to download sensitive information and store it on the encrypted file system. Since the file system appears identical to other file systems and may be mounted on top of existing application and service data directories, the applications and services can use it without modification.

On detection via data received from or analysis of one or more proximity signals, the mobile device removes the file systems encryption key from memory and un-mounts the in-memory file system. The mobile device optionally stops applications and services that have accessed the encrypted file system or may have received data from it. The mobile device optionally saves or changes the entire state of the encrypted file system to an external server before exiting the enabled location. In response to detection of unauthorized signals or signal characteristics, the device may automatically encrypt the file system, wipe the encryption key from the file system, and mount or un-mount one or more file systems.

In another embodiment, component 300 of the present invention uses proximity signals to control system access. Component 300 improves upon existing approaches having fixed privileges that are escalated via an administrator and which do not change based on physical location. The embodiment overcomes a lack of adaptive security mechanisms, which prevent mobile devices from restricting information access and certain types of computations to within a specific enabled location.

In a preferred embodiment, the present invention uses a proximity authentication mechanism and data or characteristics from one or more proximity signals to reconfigure, modify, adapt, alter or change the permission of users, applications, and services at runtime. For example, the mechanism, upon detection of a Bluetooth signal, can change the group IDs assigned to the process that runs an application in order to adapt the files and services that it can access. This adaptation mechanism can be used to restrict how information flows through system resources, such as the file system, to ensure that information can only be accessed within a specific enabled location and not leaked to insecure applications or services.

Based on detection and/or analysis and/or data received from one or more proximity signals, a mobile device determines that it has entered a specific enabled location. In response to determining that a mobile device has entered an enabled location, the mobile device may adapt the permissions of an application, user, service, or other entity. The mobile device may change the user ID associated with an application, service, process, or other entity to change permissions. The mobile device may change the group IDs associated with a user, application, process, or other entity to change permissions. The mobile device may change configuration files, such as XML files, to reconfigure, modify, adapt, alter or change the permissions of a user, group, application, service, or other entity. The mobile device may change the location of system API access points, such as the path, name, or ID that a mobile device driver is attached to, so that they cannot be accessed by applications, services, or other entities that have not been provided with the new API access points. The mobile device may change the location of key system configuration files so that they cannot be found by applications, services, or other entities that have not been informed of their new location. In response to detection of unauthorized signals or signal characteristics, the mobile device may automatically create users and user groups or change the permissions of users, groups, applications, services, or other entities in the system.

Another embodiment of the invention provides component 400 that uses proximity signals to control virtual machines and application containers. The embodiment can be used with mobile devices that support virtual machines such as virtual OS instances or other containers, such as chroot jails, to isolate parts of the computing system from each other.

This embodiment of the present invention uses one or more proximity signals to determine when a mobile device has entered an enabled location. Upon affirming that an enabled location has been properly entered, the mobile device may launch, configure, alter, or shut down virtual machines or containers in order to control access to information and specific computations while within or outside of the enabled location. For example, the mobile device may create an environment that can be used to create and host a separate virtualized copy of the software system, such as a chroot jail, and launch an application inside of the chroot jail so that the application cannot access information outside of the jail while the mobile device is in the enabled location. This allows virtual machines and containers to be controlled based on the enabled location that a mobile device is located within.

The mobile device uses one or more proximity signals issued by an access control device to detect entrance or exit from an enabled location. In response to detection of entrance or exit from an enabled location, the mobile device may configure one or more virtual machines or containers. In response to detection of entrance or exit from an enabled location, the mobile device may launch one or more virtual machines or containers. In response to detection of entrance or exit from an enabled location, the mobile device may shut down one or more virtual machines or containers. In response to detection of entrance or exit from an enabled location, the mobile device may launch one or more applications within one or more virtual machines. In response to detection of entrance or exit from an enabled location, the mobile device may change the network configuration of one or more virtual machines. In response to detection of unauthorized signals or signal characteristics, the device may automatically shut down virtual machines or containers.

In yet another embodiment, the present invention provides component 500 that uses one or more proximity signals to control virtual private networks. While mobile devices support virtual machines and provide access to virtual private networks based on protocols, such as IPSec, the devices lack the ability to automatically configure/create/release on entrance or exit from specific enabled locations. Another issue is that security credentials, such as certificates needed to access VPNs, must be preconfigured on the mobile device and cannot be dynamically downloaded after a mobile device has been confirmed to be within a specific enabled location based on a proximity authentication protocol.

To provide dynamic VPN configuration/setup/release for a mobile device and a VPN for when the mobile device is within a specific enabled location, the present invention uses a proximity authentication mechanism and proximity signal to, 1) determine when a mobile device has entered a specific enabled location, 2) provide the mobile device with security credentials needed to access one or more VPNs, 3) automatically connect with and and authenticate the VPN, and 4) automatically terminate the VPN connection when the mobile device determines via a proximity signal that it has left the enabled location. This embodiment of the present invention allows a device to dynamically access a VPN when it enters a specific enabled location and prevents continuing access to the VPN when a mobile device leaves the enabled location.

In as preferred embodiment, a mobile device use a proximity authentication mechanism to establish that it has entered a specific enabled location. Upon authentication through one or more proximity authentication mechanisms, an access control device provides VPN configuration information to a mobile device. The mobile device automatically configures one or more VPNs based on the information that it receives. The mobile device may then automatically connect to one or more VPNs.

In another embodiment, the mobile device optionally automatically routes all or a subset of traffic through the VPN. The mobile device optionally uses an in-memory file system to temporarily store certificate and configuration information for one or more VPNs. The VPN may optionally be specific to data that can be accessed within as specific enabled location. In response to determining via a proximity signal that the mobile device has left the enabled location, the mobile device automatically disconnects from the VPN and optionally removes configuration information, such as certificates, from memory and storage. In response to detecting unauthorized proximity signals or unauthorized signal characteristics, the mobile device may automatically disconnect the VPN and remove configuration data.

Another embodiment of the invention provides component 600. The embodiment improves upon existing approaches to policy enforcement, which rely on static policies that are based on the user of the mobile device or other static properties of the mobile device. To provide a dynamic solution that uses custom policies, such as within or outside of an enabled location, the present invention uses one or more proximity signals to allow policies to become active only when specific proximity signals are detected or meet specific criteria.

In this embodiment, a mobile device uses a proximity authentication mechanism to establish that it has entered a specific enabled location. Upon authentication through a proximity authentication mechanism, an access control device optionally provides a set of policies to be enforced on the mobile device while it is receiving the proximity signal or within the enabled location. The mobile device automatically enforces policies that are associated with the proximity signal or the enabled location. Upon detection that the mobile device is no longer within the enabled location, an indication that the signal no longer meets specific criteria, or that data on the proximity signal indicates termination of the connection, the mobile device ceases to enforce the policies associated with the proximity signal.

In yet another embodiment, the present invention provides a method and system for utilizing proximity authentication and related proximity signals to establish initial communication by hopping synchronization data between a mobile device and one or more access control devices, servers or other devices within a specifically enabled location. Synchronization of data in this manner enables dynamically altering communications between the mobile device and other access control devices, servers or devices in order to prevent an attacker from eavesdropping on or interfering with inter-device communications.

By exchanging synchronization data within the enabled location and coupling it with proximity authentication, one embodiment of the present invention minimizes the potential for such data being intercepted and avoids performance and limitations of preconfigured approaches. The embodiment has uses with hopping schemes that may dynamically change communication frequencies, IP addresses, ports, encryption keys, channels, waveforms, or other communication characteristics to prevent an attacker from eavesdropping on or interfering with a communication. As shown in FIG. 4A, this embodiment of the present invention provides a mechanism for using a proximity authentication mechanism to establish that a mobile device 250 has come within proximity signal range of as coordinating access control device 252 and then uses a proximity signal 260 to send the initial hopping synchronization data 270A to the mobile device for storage 270B so that it can communicate with the access control device 252 as well as one or more servers or other devices, which have likewise come within the enabled location.

This invention allows a plurality of locations to have specific hopping protocols to prevent outside attackers from eavesdropping or disrupting communications. The embodiment allows users, which share a location, to discover and synchronize on a shared hopping protocol for communication with each other.

Once a mobile device has been authenticated and receives the synchronizing data, the data may have a limited or predetermined lifetime. For example, synchronized secure communications might terminate when a mobile device leaves an enabled location or after a certain amount of time has passed. Proximity mechanisms include, but are not limited to, physical touch devices such as near-field communication cards as well as short-range wireless technologies such as Bluetooth.

In a preferred embodiment, a mobile device uses a proximity authentication mechanism to establish that it has come within proximity signal range of an access control device. Upon authentication through a proximity authentication mechanism, an access control device provides dynamic synchronization information or protocol data to a mobile device. The mobile device also may automatically configure a dynamic communications protocol, which may be a hopping protocol, using the data it receives.

The mobile device may also communicate over a proximity communication channel with an access control device by using to hopping protocol. The mobile device may communicate over a wireless interface, such as Wi-Fi, using the hopping protocol. The mobile device may communicate with other devices in the location by using one or more communication protocols. The mobile device may automatically detect, via the proximity signal, when it has left the enabled location. Upon detection of an unauthorized signal, or upon detecting that it has left the enabled location, the mobile device may remove or wipe the hopping protocol synchronization data from memory, and cease communication with the hopping protocol.

The access control device and/or the mobile device need not remain within signal range of the communicating devices during the session. The communication may self-terminate upon a predetermined event such as elapsed time. The mobile device may optionally use an in-memory file system, as described above, to store the hopping synchronization information.

In response to detecting unauthorized proximity signals or signal characteristics, the mobile device may automatically wipe the hopping synchronization data from memory and cease communicating with the hopping protocol as shown in FIG. 4B. In response to detecting a communication that does not correctly follow the hopping protocol configured with the hopping synchronization data, the mobile device may enter an out-of-room state, tamper state, attack state, or other predefined state. In response to detecting a communication that does not correctly follow the hopping protocol, an access control device may cease to broadcast proximity signals. In response to detecting a communication that does not correctly follow the hopping protocol, an access control device may further cease to provide access to information as well as entering an out-of-room state, tamper state, attack state, or other predefined state.

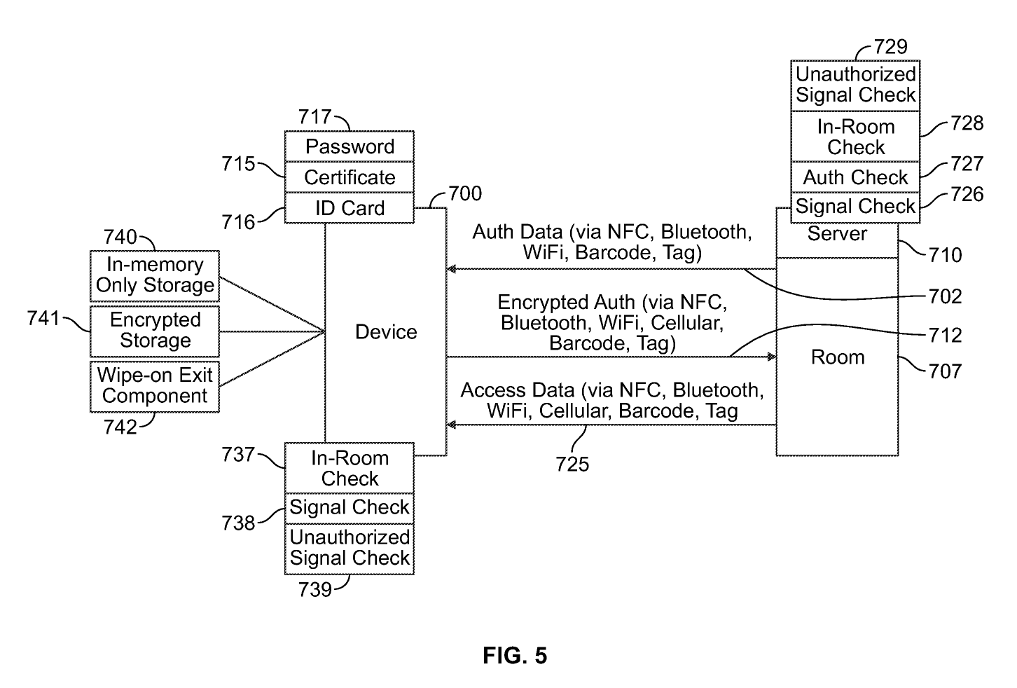

In a further embodiment of the present invention, as shown in FIG. 5, the present invention provides a proximity authentication process for mobile devices, based on Bluetooth or other short-range communication format, such as Near-Field Communication (NFC), to establish that a mobile device has entered and exited an enabled location. The process may operate on top of or in connection with standard sensor or communication channels that are currently available.

The proximity authentication process may control access to a wireless network, computing resources on servers accessible from the enabled location, computing resources or capabilities on the mobile device, or specific information that can only be accessed when the proximity signal is active. The invention can also operate with different combinations of Wi-Fi, Bluetooth, NFC, barcodes, fiducial markers, or other unique indicators. In a preferred embodiment of the invention, the device receives an NFC signal from an access control device associated with an enabled location.

In another preferred embodiment, as shown in FIG. 5, mobile device 700 receives authentication data 702 from a short-range signal such as an NFC signal pertaining to enabled location 707 from access control device 710. The strength of the signal is such that it does not extend significantly beyond the enabled location in which mobile device 700 is to operate.

Mobile device 700 encrypts authentication data 702 received via the short range signal and sends the signal to access control device 710 via Bluetooth, Wi-Fi, NFC, barcode or some other short-range signal that does not extend past the zone of operation of the enabled location with optional additional authentication data stored such as certificates 715, keys, scanned signatures cards, ID cards 716, passwords 717, and password hashes by access control device 710. Access control device 710 optionally performs step 726, which checks the signal strength by checking noise, or other characteristics of the transmission, to determine if the mobile device is in the enabled location 707.

Access control device 710 decrypts the authentication data and performs step 727 which checks the authenticity of the signal and performs step 728 which checks to determine if the mobile device is within enabled location 707. Access control device 710 upon failing to receive authentication through some combination of proximity signals and/or tailing to receive a signal that meets signal characteristic criteria, terminates access of the mobile device to information. If the authentication check fails, and after performing step 729 to determined if there is an unauthorized signal, access control device 710 may automatically enter as different state, such as the out-of-room state, a tamper state, or an under attack state.

If it is determined that mobile device 700 is properly in enabled location 707, access control device 710 sends access data 725 back to mobile device 700 via Bluetooth, Wi-Fi, cell signal, NFC, Barcode or some other short-range signal that may not extend past the zone of operation of the enable location. The data may include an encryption key, certificate, or token. The data may include to session ID. The data may include a seed for a hopping scheme to guide communication (e.g. changing TCP/UDP ports, IP addresses, encryption keys, frequency, etc.) as described above. The data may include a time value for re-authentication or session maintenance operations. The data may include policies that change the operation of the OS, middleware, or applications on the device.

Mobile device 700 optionally performs step 737 to determine if it is within the enabled location 707 by performing step 738 which checks the signal properties of the transmission. Determining the signal strength or noise may check the signal for authenticity. Mobile device 700 optionally performs step 740 that stores the data in a memory and before doing so, step 741 may be performed which encrypts the data for storage.

Mobile device 700 uses the returned data to access information stored on either the access control device or the mobile device. Mobile device 700 continues to monitor and perform signal check 738 of proximity signal 702.

Upon failing to receive the proximity signal and/or having the signal qualities fail to meet certain criteria, mobile device 700 uses logic, such as timeouts and other ways known to those of skill in the art to determine that it is no longer within the room and terminates access to received data. Once mobile device 700 determines that it is no longer receiving valid proximity signals, mobile device 700 may be configured to optionally perform a removal or wipe step 742 of all information accessed from memory and/or disk. Mobile device 700 may also optionally be configured to perform an encryption step 741 and save the information received in memory 740. In response to performing step 739, which checks for the presence of unauthorized signals or signal characteristics, the mobile device or access control device or both may automatically enter a different state, such as the out-of-room state, a tamper state, or an under attack state.

In another embodiment, the present invention provides an enabled location in which authentication data is transmitted using a Bluetooth, NFC, RFID, barcode, fiducial marker, or another short-range signal transmitted within the enabled location that is adapted not to extend outside the enabled location. The access control device optionally performs the step of checking the signal strength, noise, or other characteristics of the transmission to determine if the device is in the enabled location. The access control device performs a decryption step that checks the authentication data and determines whether or not the mobile device is within the enabled location.

Upon determining that the mobile device is properly present, the access control device sends access data back to the mobile device via Bluetooth, cell signal, or NFC or through a short-range signal described above. The data may include an encryption key, certificate, or token or a unique identifier. The data may include a session ID. The data may include a seed for a hopping scheme to guide communication (e.g. changing TCP/UDP ports, IP addresses, encryption keys, frequency, etc.). The data may include a time value for authentication, re-authentication or session initiation and/or maintenance operations. The data may include policies that change the operation of the OS, middleware, or applications on the mobile device. The mobile device and/or access control device optionally checks the signal properties of the transmission, such as signal strength and noise, to determine if the other device is still in the enabled location.

The mobile device optionally stores the data in memory only or encrypts the data for storage. The mobile device uses the returned data to access information stored on either the access control device or other authorized mobile devices. The mobile device and/or access control device continues to monitor and check the characteristics such as signal strength, noise, and the like, of a proximity signal transmitted through either a single or combination of Bluetooth, NFC, Wi-Fi, cellular or a short-range signal. Upon failing to receive the proximity signal and/or having the signal qualities fail to meet certain criteria, timeouts or other triggers are used by the mobile device and/or access control to determine that a device is no longer within the enabled location and access to received data or communications are terminated. Alternately, a failure to receive authentication through some combination of proximity signals and/or failure to receive a signal that meets signal characteristic criteria, terminates access as well. The mobile device and access control device may optionally wipe all information accessed during the session. The mobile device and/or access control device may optionally encrypt and save the information received for later use. In response to detection of unauthorized signals or signal characteristics, the mobile device and access control device may automatically enter a different state, such as the out-of-room state, a tamper state, or an under attack state.

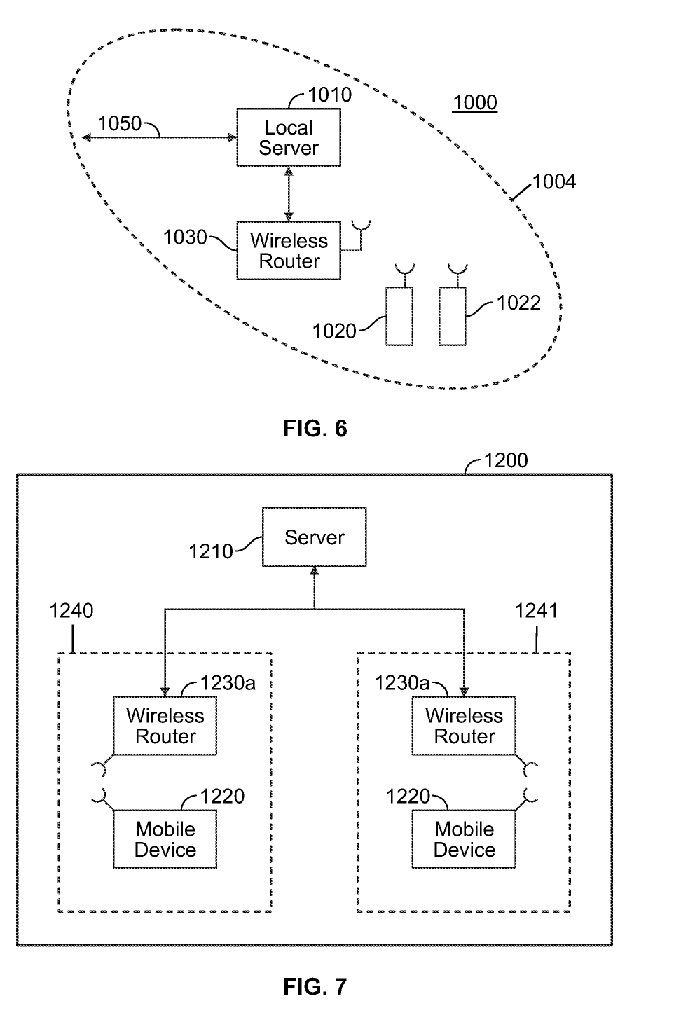

Mobile devices may be operative to receive location-based content, data, or communications in accordance with the principles of the present invention as described above and further herein. Location-based content, content, data, or communications as defined herein, refers to any content, data, or communications that relate to a particular enabled location and that may be received by a mobile device. In some embodiments, the location-based content, data, or communications may be received over a wireless communications path as described above. FIG. 6 is a diagram of a system 1000 that provides location-based content, data, or communications over a wireless communications path to one or more mobile devices in accordance with the principles of the present invention. FIG. 6 may be a specific implementation of the system 100 discussed above for use in a enabled location as shown by the dashed lines.

As shown, server 1010 functions as an access control device that is connected to wireless router 1030. Wireless router may cast a short-range wireless network that is local to a particular location, which may be a retail site or any other structure, setting or establishment. Enabled location 1004 encompasses mobile devices 1020 and 1022 and at least a portion of the enabled location in which a wireless router resides. Local server 1010 may provide local content, data, or communications to wireless router 1030 for distribution to mobile devices 1020 and 1022 and any other authorized mobile device within the wireless local network. The local content, data, or communications may be loaded onto server 1010 locally as known to those of skill in the art. Local content, data, or communications may also be obtained front a remote server (not shown) by accessing an external network. Server 1010 may include a database for storing information such as the local content, data, or communications to be accessed or received by a mobile device. If desired, another database may be maintained at a central server located remote to establishment for storing the content, data, or communications. Local server 1010 may be operative to receive data from mobile devices 1020 and 1022 and process that data in response to a request or command received from a mobile device.

FIG. 7 is a block diagram of as system 1200 that provides location-based content over a wireless communications path to one or more mobile devices in accordance with the principles of the present invention. System 1200 may be referred to as a distributed network. System 1200 includes one or more wireless routers 1229 and 1230 that may be connected to server 1210. Each wireless router may have its own local area network, delimited by the dashed lines 1240 and 1241. Thus any mobile device 1220 located within a particular wireless router's local network may be able to communicate with server 1210. An advantage of a system 1200 is that the enabled location of each wireless router 1240 and 1241 may be known. Providing a plurality of overlapping routers is advantageous because it provides the capability of obtaining a device's location through triangulation and other techniques known to those of skill in the art.

Knowing the location of a mobile device has a number of advantages. For example, as mobile device 1220 moves from one enabled location associated with a particular router's local network to another, the mobile device may automatically download or be authorized to download or receive content, data or communications specific to a particular enabled location associated with or assigned to a specific router. For example, if server 1210 detects the location of an authorized mobile device 1220 to be in the enabled location served by muter 1230 in enabled location 1241, server 1210 may authorize device 1220 to receive content, data or communications from router 1230. Then, when mobile device 1220 establishes communication with router 1229 in enabled location 1240, server 1210 may issue a signal that authorizes mobile device 1220 to receive content, data or communications for a different enabled location served by or specific to router 1229. Thus, specific content, data or communications may be accessed based on a detected enabled location of a mobile device as it moves from enabled location to enabled location.

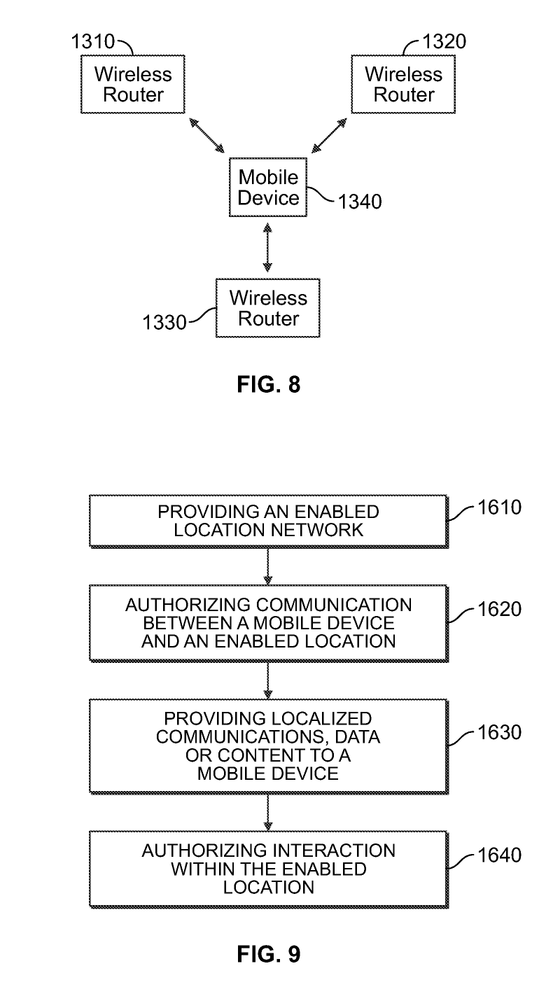

FIG. 8 illustrates how one or more wireless routers may be used to determine a location of a mobile device in accordance with the principles of the present invention. As shown, three or more wireless routers 1310, 1320, and 1330, are provided, each of which may or may not be connected to the same server. Each router may be associated with a known enabled location. Thus when mobile device 1340 communicates with any one of routers 1310, 1320, or 1330, the approximate location is known because the range of routers 1310, 1320, and 1330 may be limited to a predetermined distance. With each additional router mobile device 1340 communications with, the resolution of the location of the mobile device 1340 may improve.

An electronic signal may be used to further narrow down the enabled location of mobile device 1340. The electronic signal may be a time stamp, encryption key, certificate, token or some other unique identifier. The identifier is used by the access control device to determine the authenticity and/or the time it was sent to and received from the mobile device. Based on this information, secure communications between the access control device and mobile device may be enabled for the specific enabled location.

FIG. 9 is a flowchart showing steps that may be taken to provide localized content, data or communications to a mobile device in accordance with the principles of the present invention. At step 1610, a network for a specific enabled location is provided. The network may be a local wireless network, a local wired network, or a distributed network such as those discussed above. At step 1620, communication between a mobile device and the enabled location is established. At step 1630, localized communications, data or content may be provided to the mobile device. At step 1640, a user may be allowed to interact with or access to the enabled location.

To prevent unauthorized devices from accessing the communication between an enabled location and an authorized mobile device, unauthorized interference between the enabled location or an authorized mobile device, the mobile device upon entering an enabled location, receives a signal corresponding to an enabled location. The received signal may include an encryption key, certificate, token, time stamp, session identifier or some other unique indicator or reference that uniquely identifies the communication between the mobile device and access control device. Using the identifier, an authorization specific routine for establishing an authorized communication between the enabled location and mobile device may be implemented in accordance with the steps described above. For example, a specific hopping routine, encryption key, encrypted file system, encrypted communication and the like may be assigned, implemented or established between the access control device and the mobile device within a specific enabled location. Thus, any subsequent requests from other devices, communications or attempts to access the prior authorized communications, will be recognized as being subsequent-in-time and unauthorized thereby preventing access to the prior authorized communications and data.

The methods and systems described herein may be deployed in part or in whole through a mobile device and/or access control device that executes computer software, program codes, and/or instructions on a processor. The present invention may be implemented as a method on the device, as a system or apparatus as part of or in relation to the device, or as a computer program product embodied in a computer readable medium executing on one or more devices.

In other embodiments, the processor may be part of a server, cloud server, client, network infrastructure, mobile computing platform, stationary computing platform, or other computing platform. A processor may be any kind of computational or processing device capable of executing program instructions, codes, binary instructions and the like. The processor may be or include a signal processor, digital processor, embedded processor, microprocessor or any variant such as a co-processor (math co-processor, graphic co-processor, communication co-processor, etc.) and the like that may directly or indirectly facilitate execution of program code or program instructions stored thereon. In addition, the processor may enable execution of multiple programs, threads, and codes. The threads may be executed simultaneously to enhance the performance of the processor and to facilitate simultaneous operations of the application.

The methods, steps, operations, program codes, program instructions and the like described herein may be implemented by any of the devices described above. In addition, the methods, steps, operations, program codes, program instructions and the like described herein may be implemented in one or more threads. The thread(s) may generate other threads that may have assigned priorities associated with them; the device or processor may execute these threads based on priority or any other order based on instructions provided in the program code. The processor, or any device utilizing one, may include a memory that stores methods, codes, instructions and programs as described herein and elsewhere. The processor may access a storage medium through an interface that may store methods, codes, and instructions as described herein and elsewhere. The storage medium associated with the processor for storing methods, programs, codes, program instructions or other type of instructions capable of being executed by the computing or processing device may include but may not be limited to one or more of a CD-ROM, DVD, memory, hard disk, flash drive, RAM, ROM, cache and the like.

In accordance with the above disclosure, another embodiment of the invention provides a system for restricting access to information using short range wireless communications having a short range wireless network serving a predetermined environment, location or enabled location. The network is configured to provide authentication data to a computing device which may be a mobile computing device. The authentication data may be specific to the environment, location or enabled location. The authentication data may include a unique identifier associated with the network, the specific location, the computing device or all of these elements. The network may be further configured to receive back from the computing device the authentication data along with an indication that the computing device has received the authentication data as well as a unique identifier associated with the computing device that identifies the device. Upon verification that the communication with the computing device is authorized, the network permits communication between the computing device and the network for use in the predetermined location.

In another version of some embodiments, the system of the present invention includes one or more access control devices that transmit initiation signals to the network, computing device or both. The access control devices may be associated with and operable for one or more enabled locations.

The system may further include a server to receive authentication data from the computing device. In other embodiments, the system may include a plurality of access control devices that transmit the initiation signals.

In other aspects, some embodiments of the present invention provide a unique identifier that is composed of a plurality of distinct components. The unique identifier may be composed of a string of characters, a string of bytes or a hopping signal.

The network upon verifying the authentication data may send a signal or communication to modify, enable, disable or alter an inter-process communication or function of the computing device. Inter-process commutations or functions that may be disabled or altered include text messaging, phone calling capabilities, a designated software application, Internet access, or some other functional feature.

Some embodiments of the present invention provide a system for controlling one or more inter-process communications of a computing device which may be a mobile device. The system may include a short range wireless network serving a predetermined environment, location or enabled location. The network may be configured to provide authentication data to a user computing device. The authentication data may be specific to the environment, location or enabled location. The authentication data may include a unique identifier. The network may be configured to receive from the computing device the authentication data as well as a unique identifier associated with the computing device. Once the network verifies the authentication data received from the computing device, the network sends a communication that alters an inter-process communication of the computing device for the particular location, environment or enabled location. Inter-process communications that may be altered include, but are not limited to, text messaging of said computing device, phone calling capabilities of the computing device, access to Internet communications, or some other functional features. In addition, the system may be configured to receive and recognize a unique identifier associated with the computing device.

While the foregoing written description enables one of ordinary skill to make and use what is considered presently to be the best mode thereof, those of ordinary skill will understand and appreciate the existence of variations, combinations, and equivalents of the specific embodiment, method, and examples herein. The disclosure should therefore not be limited by the above described embodiments, methods, and examples, but by all embodiments and methods within the scope and spirit of the disclosure.

What is claimed is:

1. A system for restricting access to information using short range wireless communications, the system comprising:
a short range wireless network serving a predetermined enabled location;
said network configured to provide authentication data to a computing device, said authentication data specific to said enabled location;
said authentication data including a unique identifier;
said network configured to receive from said computing device said authentication data;
said network verifies said authentication data received from said computing device; and
upon verification said network permits communication between said computing device and said network for said predetermined location.

2. The system of claim 1 including an access control device that transmits initiation signals.

3. The system of claim 1 including as server to receive authentication data from said computing device.

4. The system of claim 1 including a plurality of access control devices that transmit initiation signals.

5. The system of claim 1 wherein said unique identifier is composed of a plurality of distinct components.

6. The system of claim 1 wherein each said unique identifier is composed of a string of characters.

7. The system of claim 1 wherein each said unique identifier is composed of a string of bytes.

8. The system of claim 1 wherein said unique identifier is as hopping signal.

9. The system of claim 1 wherein said network upon verifying said authentication data, said network sends a communication to alter an inter-process communication of said computing device.

10. The system of claim 1 wherein said network upon verifying said authentication data, said network sends a communication to disable text messaging of said computing device.

11. The system of claim 1 wherein said network upon verifying said authentication data, said network sends a communication to alter a specific software application of said computing device.

12. The system of claim 1 wherein said network is configured to receive a unique identifier associated with said computing device.

13. The system of claim 1 wherein said network upon verifying said authentication data, said network sends a communication to activate a specific software application of said computing device.

14. A system for controlling the inter-process communication of a computing device comprising:
a short range wireless network serving a predetermined enabled location;
said network configured to provide authentication data to a computing device, said authentication data specific to said enabled location;
said authentication data including a unique identifier;
said network configured to receive from said computing device said authentication data;
said network verifies said authentication data received from said computing device; and
upon verification said network sends a communication that alters an inter-process communication of said computing device.

15. The system of claim 14 wherein said network upon verifying said authentication data, said network sends a communication to disable text messaging of said computing device.

16. The system of claim 14 wherein said network upon verifying said authentication data, said network sends a communication to alter a specific software application of said computing device.

17. The system of claim 14 wherein said network is configured to receive a unique identifier associated with said computing device.

18. A method of a restricting access to information using short-range wireless communications, the method comprising:
providing a short range wireless network serving a predetermined enabled location;
configuring said network to provide authentication data to a computing device, said authentication data specific to said enabled location;
configuring said authentication data to include a unique identifier;
configuring said network to receive from said computing device said authentication data and to verify said authentication data received from said computing device; and
upon verification, said network permits communication between said computing device and said network for said predetermined location.

19. The method of claim 18 wherein said network upon verifying said authentication data, said network sends a communication to alter an inter-process communication of said computing device.

20. The system of claim 18 wherein said network upon verifying said authentication data, said network sends a communication to disable text messaging of said computing device.

21. The system of claim 18 wherein said network upon verifying said authentication data, said network sends a communication to alter a specific software application of said computing device.
